(19) United States
(12) Patent Application Publication
(10) Pub. No.: US 2013/0154818 A1
(43) Pub. Date: Jun. 20, 2013

(54) EXPANDABLE INSTRUMENT CLUSTER

(71) Applicant: GM GLOBAL TECHNOLOGY OPERATIONS LLC, Detroit, MI (US)

(72) Inventor: Holger WEYER, Wiesbaden-Bierstadt (DE)

(73) Assignee: GM GLOBAL TECHNOLOGY OPERATIONS LLC, Detroit, MI (US)

(21) Appl. No.: 13/710,076

(22) Filed: Dec. 10, 2012

(30) Foreign Application Priority Data
Dec. 15, 2011 (DE) 102011121283.7

(51) Int. Cl. B60Q 1/00

(52) U.S. Cl. CPC B60Q 1/00
USPC 340/441; 340/438; 340/459

(57) ABSTRACT

An instrument cluster for a motor vehicle is provided. The instrument cluster includes at least one display instrument with an annular segment-like display scale and a needle. Here, the display instrument comprises devices for the mechanical fixing and for the electrical contacting of at least one add-on instrument, which can be releasably attached within the display scale. The present disclosure makes possible the simple upgrading of a motor vehicle with additional add-on instruments. Further embodiments provide that an add-on instrument can also be used as a vehicle key.

### CROSS-REFERENCE TO RELATED APPLICATION

This application claims priority to German Patent Application No. 10 2011 121 283.7, filed Dec. 15, 2011, which is incorporated herein by reference in its entirety.

### TECHNICAL FIELD

The technical field relates to an instrument cluster for a motor vehicle, wherein at least one add-on instrument can be releasably attached and furthermore a motor vehicle comprising such an instrument cluster.

### BACKGROUND

Instruments in vehicle constitute important vehicle components, which impart to the vehicle occupants and in particular the driver information regarding travelling or operating states of the vehicle. Some instruments are indispensible for a safe vehicle operation, for example a speedometer, while others depending on equipment variant of a vehicle or preferences of its owner are present or absent. For example, basic models occasionally lack a coolant temperature display that is standard in the case of models of high-end equipment series. Usually, an instrument equipment item configured within the scope of the vehicle production cannot be subsequently changed or only with considerable constructional effort so. In the past, efforts were therefore made to configure the equipment of motor vehicles with instruments more flexibly.

U.S. Pat. No. 6,441,510 B1 describes a configurable instrument panel with plug-in slots into which modular instruments can be inserted. By way of plug contacts, a connection with a universal wiring of the vehicle is established here. Although this system allows a certain flexibility with the original equipment of a vehicle with instruments and under certain conditions may make possible the subsequent exchange of instruments, it does not however permit any additional attachment of instruments in the event that all instrument slots are already occupied. DE 10 207 006 985 A1 describes an instrument module cluster for dashboards, wherein at least one peripherally detachable module can be attached to a closed basic module with at least one display. However, this solution requires as a prerequisite dashboards wherein in the periphery of a basic module sufficient space has to be available in order to be able to attach a further module in the first place, wherein this place also has to be comfortably viewable for reasons of ergonomics and driving safety. In view of the disadvantages of these solutions and the importance of instruments for the operation of motor vehicles as well as the necessity for vehicle manufacturers to allow as variable as possible an equipment of their vehicles in a simple manner, there is a need for further solutions. In addition, other objects, desirable features and characteristics will become apparent from the subsequent summary and detailed description, and the appended claims, taken in conjunction with the accompanying drawings and this background.

### SUMMARY

According to various exemplary embodiments, an instrument cluster for a vehicle, in one example, for a motor vehicle, is provided, which comprises at least one display instrument with an annular segment-like display scale and a needle. Such annular segment-like display scales are thoroughly known and are routinely used for example for speedometers and tachometers, wherein the position of the needle over the display scale correspondingly indicates the current speed or current engine rotational speed. With the instrument cluster according to the present disclosure the display instrument comprises devices for the mechanical fixing and for the electrical contacting of at least one add-on instrument, which can be releasably attached within the display scale by means of the device for the mechanical fixing. An attachment within the display scale in terms of the present disclosure means that the add-on instrument following the attachment comes to lie at least partially in the region of the display scale, generally within the region enclosed by the annular segment-like display scale. Here, the device for the mechanical fixing need not necessarily lie within the display scale. Further exemplary embodiments provide that the device for the mechanical fixing lies in the region of the margin of the display instrument, so that this device does not visually interfere with the display scale even with the add-on instrument not attached.

Through the present disclosure, a simple, cost-effective and flexible system is provided, to attach add-on instruments in a motor vehicle. In addition to this it is advantageously possible to attach these such that no additional external space, for example in the periphery of the display instrument, i.e. outside the display instrument is required, but a space within the display scale is additionally utilized. Since display scales even for reasons of driving safety are arranged so that they correspond to ergonomic criteria, an automatic ergonomic positioning of the add-on instrument is thus advantageously ensured.

The shape of the add-on instrument that is positioned over the display scale of the at least one display instrument is configured in one example, so that important or information-carrying areas of the display scale are not concealed. If parts of the add-on instrument come to lie over corresponding areas of the display scale their readability can be continuously ensured through transparent parts.

According to one exemplary embodiment, the display instrument is a speedometer. Since even with the simplest motor vehicles in the low-end vehicle segment a speedometer is always present, the instrument cluster according to the present disclosure can be advantageously employed from the low-end to the high-end vehicle segments. Usual dashboards in at least medium-range vehicle segments as a rule comprise two main display instruments with annular segment-like display scale, of which one is the speedometer and the other one a tachometer or an analogue clock. With such dashboards, instrument clusters of various exemplary embodiments according to the present disclosure can be present either on the speedometer or on the tachometer or the analogue clock or both on the speedometer and the tachometer or the analogue clock.

The add-on instrument can be any instrument that displays data in an analogue, digital or graphical manner, for example via pictograms or diagrams. The data can be such as does not originate from the vehicle or data that are created in the vehicle. Non-restrictive examples for add-on instruments displaying data, which need not necessarily be created in the vehicle, are clocks, compasses, thermometers, pressure gauges and monitors, for example additional monitors for DVD play-back devices or other electronic devices. Non-restrictive examples for add-on instruments displaying data generated in the vehicle are speedometer, tachometer, odometer, tank displays such as for example fuel tank displays or windshield wiper fluid displays, consumption displays, cooling water temperature displays, oil water displays, oil pressure displays, needle displays, operating displays for additional devices such as for example additional headlamps, and likewise monitors. In principle, the add-on instruments can be configured as analogue or digital display instruments. For example, an additional thermometer instrument can display the inside or outside temperature in an analogue or digital manner, or a speedometer add-on instrument can, besides the usual analogue display of the speed, additionally output said speed digitally through a display instrument that is already present. As a further example, consumption displays can show the current or average fuel consumption in an analogue manner by means of a needle position, digitally as a number or graphically for example as travelling in a consumption range that is marked as being favorable or unfavorable through colors. If the add-on instrument is present in the form of a monitor, another exemplary embodiment of the present disclosure provides a change-over possibility between analogue, digital and, if applicable, graphic display. Additional devices in the form of monitors are suitable in one example, for displaying in a favorably viewable manner information of navigation devices, telephones or a vehicle computer, for example current error messages in the region of the instrument cluster. The presentation of previously non-existing displays or the presentation of already existing displays in an alternative manner is advantageously made possible through the add-on instrument.

According to one exemplary embodiment, the at least one add-on instrument of the instrument cluster according to the present disclosure comprises an individual energy source, for example a battery or a rechargeable accumulator. For example, the add-on instrument is a clock the operation of which is ensured from an individual energy source. According to other various exemplary embodiments, the add-on instrument is supplied with energy or operating voltage from the vehicle via the electrical contacting. For example, the add-on instrument in this case is a clock that is supplied with voltage from the vehicle. Further variations of this exemplary embodiment provide that with the operating voltage the display data are also transmitted from the vehicle to the add-on instrument. If the add-on instrument is for example a tachometer or an oil temperature display, the current engine rotational speed or oil temperature is represented through the respective operating voltage provided.

According to another exemplary embodiment, display data are transmitted to the add-on instrument through the electrical contacting in addition to or instead of operating voltage. The display data are present in analogue or digital form and ultimately determine what—if required, following processing or decoding by the add-on instrument—is displayed on said display instrument. The transmission of the data or the access to the data can be effected in the manner usual in the industry, for example through access to multiplex lines or data buses. Various exemplary embodiments of the present disclosure provide that via suitable multiplex lines or data buses access is granted to all data which are also available to a central computer of the motor vehicle and/or of the motor vehicle infotainment system. In this manner it is ensured that add-on instruments can access the entire data pool of the motor vehicle. It is clear to the person skilled in the art that a data pool is usually present in a motor vehicle which is not necessarily output completely via instruments, but often only serves for the internal control. If for example no cooling water temperature gauge is present in a motor vehicle, a cooling water measuring probe that registers the temperature data, controls the radiator fan and activates a warning lamp on the dashboard when a maximum temperature of the cooling water fluid is exceeded is nevertheless present as a rule. According to the present disclosure, an add-on instrument can now be attached which accesses the temperature data of the cooling water measuring probe that were not previously accessible to the vehicle occupants, displaying the relevant temperatures in an analogue or digital manner.

The electrical contacting according to various exemplary embodiments of the present disclosure is effected via means usual in the industry for example via wiping contacts or via connectors with pins. Connectors can be used in one example which in addition to the transmission of operating voltage and/or display data, partially or entirely also take over the mechanical fixing, for example by way of screw or clip closures attached to the connector that are usual in the industry.

According to an exemplary embodiment, the add-on instrument of an instrument cluster according to the present disclosure comprises an identification part individually assigned to the vehicle. This identification part communicates with a central vehicle control unit. A starting of the motor vehicle is only permitted when the identification part is identified by the vehicle control unit. The carrying of this identification part can constitute the sole purpose of the add-on instrument or the add-on instrument can comprise the identification part and additionally serve as instrument for the display of data.

According to another exemplary embodiment, the identification part comprises a microchip, or a transponder for radio frequency identification which is also designated RFID-transponder. Following the electrical contacting of the add-on instrument to the relevant devices of the display instrument, the central vehicle control unit communicates with the microchip or the RFID-transponder via the formed electrical contact and checks if the required correct identification data are contained therein. If this is the case, the motor vehicle can be started or the operating modes of the vehicle that are permissible in the event of a positive identification can be activated, for example a switching-on of the infotainment system even without starting the motor vehicle. The electrical contacting is effected via direct mechanical contact of relevant current conductors or connectors. If the identification part comprises an RFIG-transponder, the electrical contacting can likewise be effected via a direct mechanical contact and/or wireless via radio waves, if the motor vehicle has a sufficiently strong radio frequency transmitter. In the latter case, a communication with the RFID-transponder is already possible if applicable even when the add-on instrument is still located outside the motor vehicle. The mechanical fixing later on after entering the motor vehicle in this case merely has to serve for the secure fastening of the add-on instrument, alternatively the wireless contact to the RFID-transponder can now be supplemented or replaced through a conductor-based contact. Through the aforementioned further developments, the add-on instrument can be advantageously used as vehicle key. In one example, the add-on instrument when using an RFID-transponder makes possible a vehicle operation according to the principle of “passive entry, passive start” also known by the acronym PEPS. Here, upon positive identification of the identification part, the doors are unlocked even upon sufficient approaching of the vehicle and the starting of the vehicle is made possible based on the spatial proximity to the vehicle of the add-on instrument alone. According to another exemplary embodiment, the identification part assigned to the add-on instrument constitutes a device which itself does not yet contain the data required for the identification but acts as a reading device for this data. The data itself can be present on carriers such as chip cards or RFID-cards that are usual in the industry. The add-on instrument as reading device is to be releasably attached to the display instrument and can remain in the latter when the motor vehicle is shut down. For the subsequent renewed starting, merely the corresponding carrier of the identification data has to be taken along. Alternatively, the add-on device is designed as reading device for biometric data. In this case, no carrier whatsoever is required, the starting is rather permitted when the correct biometric data are registered. Examples for corresponding reading devices for biometric data comprise fingerprint scanners, retina scanners and voice scanners. Advantageously, a motor vehicle can be subsequently provided with safety mechanisms through the aforementioned further developments, which prevent its unauthorized starting or its unauthorized usage.

Further exemplary embodiments of the instrument cluster according to the present disclosure provide for a wireless data exchange between the motor vehicle and the add-on instrument. For this wireless data exchange, means that are usual in the industry can be used, for example Bluetooth, infrared interfaces or radio waves, wherein the motor vehicle and/or the display instrument on the one hand and the add-on instrument on the other hand have corresponding Bluetooth, infrared or radio wave transmitters and/or receivers. The transmitters and/or receivers of the motor vehicle or of the display instrument in this case have access to the vehicle data to be transmitted to the add-on instrument, for example via the already mentioned multiplex lines or data buses. With wireless data exchange, the electrical contacting in one example, merely serves for providing operating voltage, so that the add-on instrument need not necessarily have an individual energy source. In the case of wireless data transmission, contactable data lines between the display instrument and the add-on device can be omitted.

According to various exemplary embodiments, the add-on instrument comprises at least one operating unit for the command input by a user. In the simplest case, the operating unit can for example be a make/break switch for the add-on device, or can make possible the selection of different operating modes of the add-on device. If the add-on device is a monitor for example, it can be selectable if certain data, for example the coolant temperature, are to be displayed in an analogue or digital manner, or it can be determined which data are to be displayed, for example the coolant temperature or the current fuel consumption. Through this exemplary embodiment, a more flexible and/or more comfortable utilization of the add-on instrument is made possible.

For the mechanical fixing of the add-on instrument, devices that are usual in the industry can be used, for example Velcro tapes, tongue/groove elements for sliding in, engagement elements, bayonet elements, screw elements, magnet elements or any combinations thereof In one example, the devices are located on the outer margin of the display instrument so that they do not visually impair the annular segment-like display scale and do not appear or do not substantially appear even when no add-on instrument is attached to the display instrument. For example, the devices are entirely or partially located behind the surface of the instrument cluster that is visible to the user of the vehicle. It is clear to the person skilled in the art that for each device for the mechanical fixing of the display instrument an associated and corresponding device if applicable is present on the add-on instrument, wherein the fixing is brought about through interaction of the device of the display instrument and the corresponding device of the add-on instrument. Examples of such devices corresponding to each other are the already mentioned tongue elements and the groove elements corresponding to these, screw elements and associated threaded bores, gripping hooks of engagement devices and corresponding depressions for receiving the gripping hooks, and magnets of opposite polarity, wherein the person skilled in the art knowing the inventive idea is now able to practically determine which device is to be present on the display instrument and on the add-on instrument. In one example, types of the mechanical fixing are effected via engagement elements or via connectors for the electrical contacting, wherein the plug connection that is brought about simultaneously causes an adequate mechanical fixing if required supported by means usual in the industry such as knurled screws, clip or engagement element on the connector, which are to prevent a disconnection of the plug connection. Through the devices, a secure mechanical fixing of the add-on instrument to the display instrument is advantageously made possible.

The present disclosure furthermore relates to a motor vehicle comprising an instrument cluster according to the present disclosure.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 is a schematic top view of a display instrument;

FIG. 2 is a schematic top view of two add-on instruments;

FIG. 3 is a schematic top view of two further add-on instruments;

FIG. 4 is a schematic top view of a display instrument with add-on instrument attached; and

FIG. 5 is a schematic perspective view of a device for the mechanical fixing and electrical contacting.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

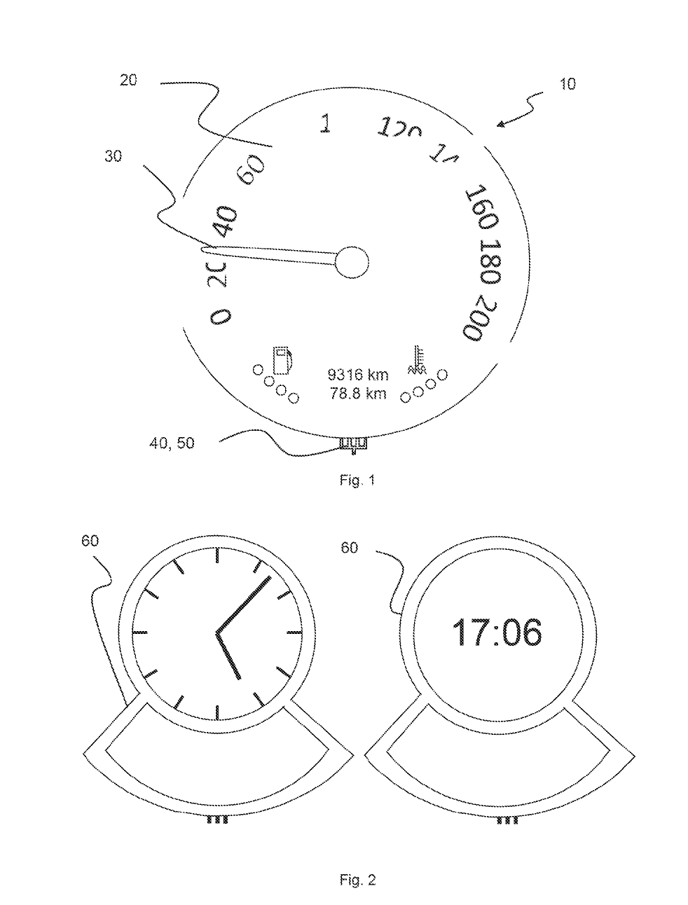

In FIG. 1, a speedometer with an annular segment-like display scale 20 and a needle 30 is schematically shown as an example for a display instrument 10 of the instrument cluster according to the present disclosure. In addition to the annular segment-like display scale 20, the display instrument 10 at the lower end still comprises further display fields for the fuel tank filling, the kilometer and daily kilometer readings and the cooling water temperature. At the lower margin of the display instrument 10 is located the output of a connector socket, which simultaneously serves as device for the mechanical fixing 40 and as device for the electrical contacting 50. The spatial arrangement of the connector socket relative to the display instrument 10 is again illustrated in FIG. 5.

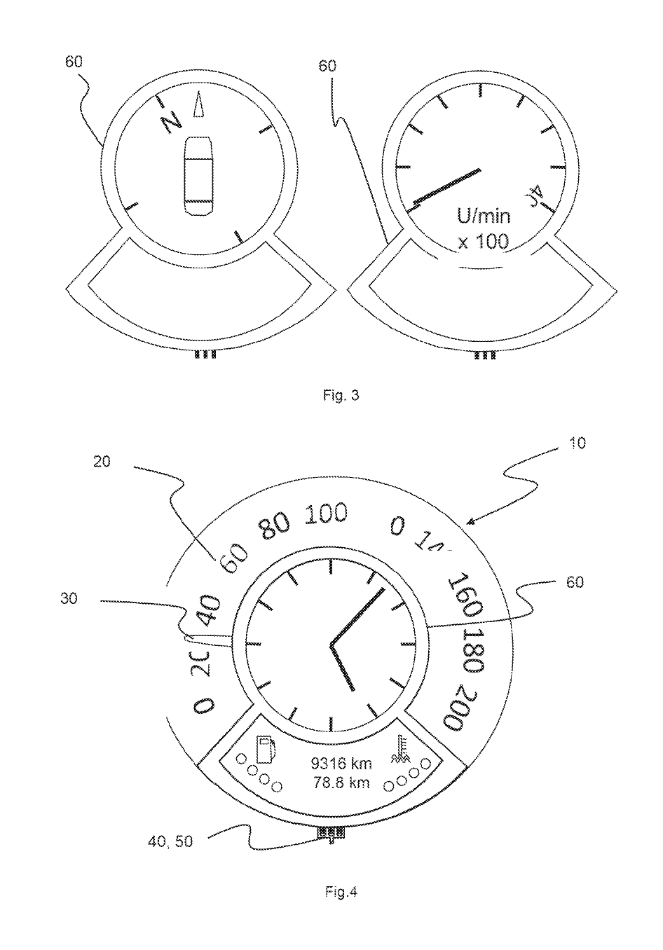

FIG. 2 schematically shows two examples for add-on instruments 60 to be attached to the display instrument 10. On the left, an analogue clock is depicted, a digital clock on the right. FIG. 3 shows further examples of add-on instruments 60, namely on the left a compass and a tachometer on the right. At the lower ends of the add-on instruments 60 are located three connector pins each for the electrical contacting and simultaneously for the mechanical contacting with the device 40, 50 of the display instrument 10.

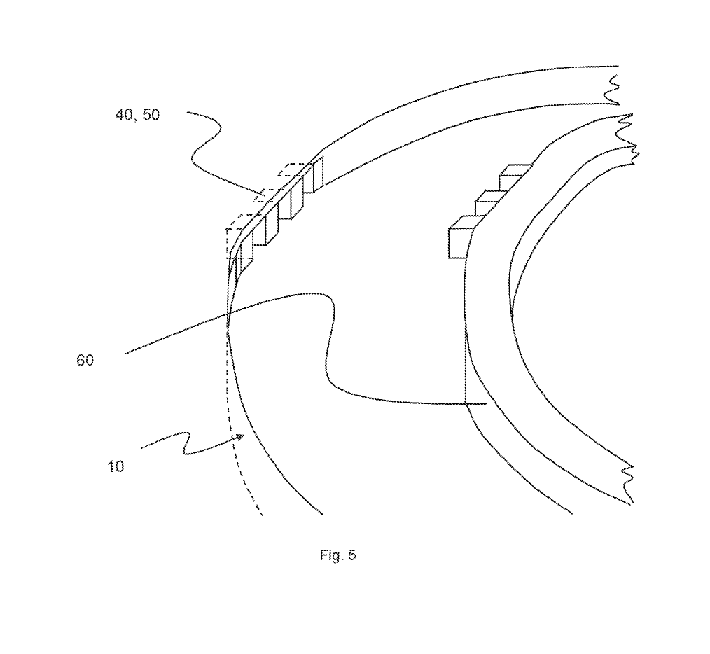

FIG. 4 schematically shows in the top view the display instrument 10 from FIG. 1, to which the add-on instrument 60 in the form of an analogue clock from FIG. 2 is attached. The connector pins of the add-on instrument 60 are inserted in the device for the mechanical fixing 40 and for the electrical contacting 50 designed as connector socket and bring about both a mechanical fixing as well as an electrical contacting. The add-on instrument 60 conceals parts of the display instrument 10 which however is not essential for the information shown by this display instrument 10. Thus, the hub of the needle 30 and an inner circular region of the display instrument 10 surrounding the hub is concealed by the analogue clock of the add-on instrument 60, the annular segment-like display scale 20 and the speed display itself however remain visible. Because of suitably provided clearances in the add-on instrument 60, the display fields for the fuel tank filling, the kilometer and daily kilometer reading as well as the cooling water temperature also remain visible without obstruction.

FIG. 5 shows a schematic perspective top view of a detail of a display instrument 10, for example the display instrument from FIG. 1, whose lower end is shown on the left margin of the picture and comprises the connector socket, which acts as device for the mechanical fixing 50 and as device for the electrical contacting 50. On the right side of the picture an add-on instrument 60 is shown as a detail, the connector pins of which upon further approximation engage in the connector socket and would bring about an electrical contacting and a mechanical fixing. Electrical lines and the additional display fields present at the lower end of the display instrument 10 and shown in the FIGS. 1 and 4 have been omitted in the Figures for the sake of clarity. The connector socket is located behind the surface of the instrument cluster or the dashboard surrounding the latter visible to the user of the vehicle, which is why the depressions which are intended for receiving the connector pins are partially drawn in interrupted line. The surrounding dashboard is not shown with details.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. An instrument cluster for a motor vehicle comprising:
at least one display instrument with an annular segment-like display scale and a needle; and
at least one add-on instrument,
wherein the at least one display instrument includes devices for the mechanical fixing and electrical coupling of the at least one add-on instrument, which can be releasably attached within the display scale.

2. The instrument cluster according to claim 1, wherein the at least one display instrument is a speedometer.

3. The instrument cluster according to claim 1, wherein the add-on instrument is selected from the group comprising: a clock, a compass display, a tachometer, a kilometer counter, a tank display, a consumption display, a cooling water temperature display, an oil temperature display, an oil pressure display, a speedometer and a monitor.

4. The instrument cluster according to claim 1, wherein the electrical coupling supplies the add-on instrument with operating voltage.

5. The instrument cluster according to claim 1, wherein via the electrical coupling display data are transmitted to the add-on instrument.

6. The instrument cluster according to claim 1, wherein the add-on instrument comprises an identification part individually assigned to the vehicle, which communicates with a central vehicle control unit and permits a starting of the motor vehicle only when the identification part has been identified by the vehicle control unit.

7. The instrument cluster according to claim 1, wherein a data exchange between the motor vehicle and the at least one display instrument is effected wirelessly.

8. The instrument cluster according to claim 1, wherein a data exchange between the motor vehicle and the add-on instrument is effected wirelessly.

9. The instrument cluster according to claim 1, wherein the add-on instrument further comprises at least one operating unit for a command input by a user.

10. The instrument cluster according to claim 1, wherein the device for the mechanical fixing is selected from the group comprising: groove and tongue elements, engagement elements, bayonet elements, screw elements and magnet elements.

11. A motor vehicle, comprising:
an instrument cluster including at least one display instrument with an annular segment-like display scale and a needle that displays a first type of data; and
at least one add-on instrument that displays a second type of data,
wherein the at least one display instrument includes devices for the mechanical fixing and electrical contacting of the at least one add-on instrument, which can be releasably attached within the display scale and the first type of data is different than the second type of data.

12. The motor vehicle according to claim 11, wherein the at least one display instrument is a speedometer.

13. The motor vehicle according to claim 11, wherein the add-on instrument is selected from the group comprising: a clock, a compass display, a tachometer, a kilometer counter, a tank display, a consumption display, a cooling water temperature display, an oil temperature display, an oil pressure display and a monitor.

14. The motor vehicle according to claim 11, wherein the electrical contacting supplies the add-on instrument with operating voltage.

15. The motor vehicle according to claim 11, wherein via the electrical contacting display data are transmitted to the add-on instrument.

16. The motor vehicle according to claim 11, wherein the add-on instrument comprises an identification part individually assigned to the vehicle, which communicates with a central vehicle control unit and permits a starting of the motor vehicle only when the identification part has been identified by the vehicle control unit.
